(19) United States
(12) Patent Application Publication
(10) Pub. No.: US 2008/0000736 A1
(43) Pub. Date: Jan. 3, 2008

(54) Drum brake with ceramic friction surfaces

(75) Inventor: Christian Bruch, Waakirchen (DE)

Correspondence Address: STEVENS DAVIS MILLER & MOSHER, LLP, 1615 L STREET, NW, SUITE 850, WASHINGTON, DC, 20036, US

(73) Assignee: Audi AG, Ingolstadt (DE)

(21) Appl. No.: 11/819,233

(22) Filed: Jun. 26, 2007

(30) Foreign Application Priority Data
Jun. 30, 2006 (DE) 10 2006 030 301.6

(51) Int. Cl. F16D 65/10

(52) U.S. Cl. 188/218 R

(57) ABSTRACT

Drum brake (1) with at least one ceramic friction layer on one of the interacting friction surfaces selected from the inner drum surface (11) which acts as a rotor and the brake shoes (14) which interact with it as the stator.

This invention relates to drum brakes with ceramic friction surfaces.

Currently two different systems of brakes are used in motor vehicles, disk brakes and drum brakes. While disk brakes are preferably used for higher braking power, due to better heat dissipation and the easier possibility of checking and changing the brake linings, drum brakes are preferred for lower braking power due to their simpler structure and insensitivity to dirt.

Drum brakes as essential components contain a cylindrical rotary housing (drum) on which pivotally mounted, otherwise stationary brake shoes are pressed from the inside (used in this way in motor vehicles) or from the outside (used for example in machinery brakes) during braking. For heavy heat development the drum expands, for inner brake shoes in the conventional design their no longer complete adjoining the inside drum wall and the brakes therefore losing action. Actuation (positioning) of brake shoes conventionally takes place by hydraulic cylinders within the drum or via rotating cams from the outside.

The more durable execution makes drum brakes attractive when it is possible to overcome the inherent disadvantages compared to disk brakes, such as especially lower braking power.

It has now been found that the use of ceramic friction materials leads to a significant improvement of braking power, without the disadvantages of poorer heat dissipation which were considered to be given in the past for drum brakes militating against suitability.

The invention therefore relates to drum brakes with ceramic friction layers on at least one of the friction surfaces which interact as the rotor or stator.

The invention will be explained with reference to the attached drawings.

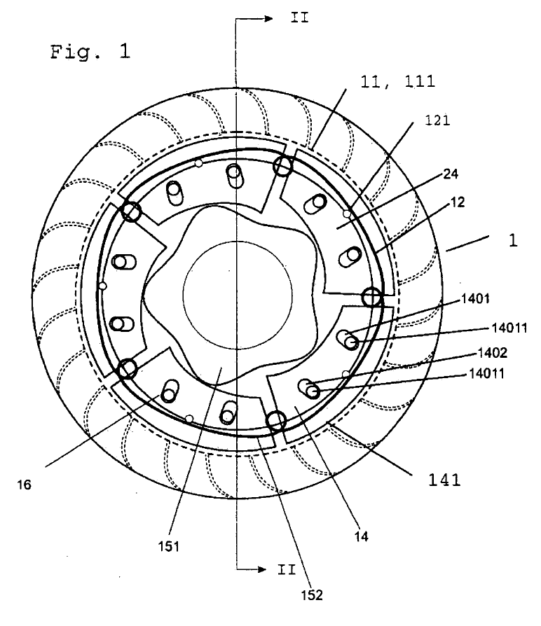

FIG. 1 shows an elevational view of a section perpendicular to the axis through a drum brake 1 with at least one ceramic friction layer on one of the interacting friction surfaces, specifically the inside drum surface 11 acting as the rotor and/or the brake shoes 14 interacting with it as a stator,

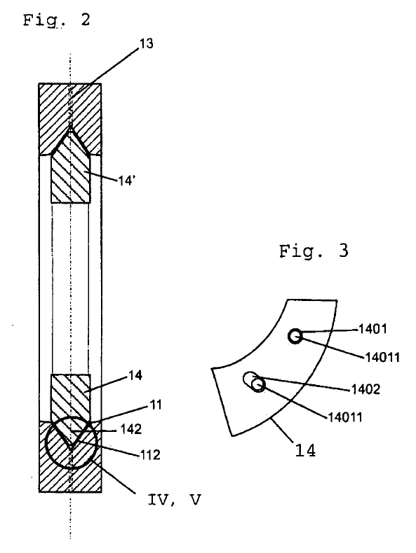

FIG. 2 shows a section along line 11-11 through a drum brake 1 in a plane containing an axle which is not shown in the drawings, to improve clarity the actuator not being shown either,

FIG. 3 shows an elevational view in the direction of the axis of the brake shoe 14 with a support by a combination of pins and a round hole and a combination of pins and an oblong hole,

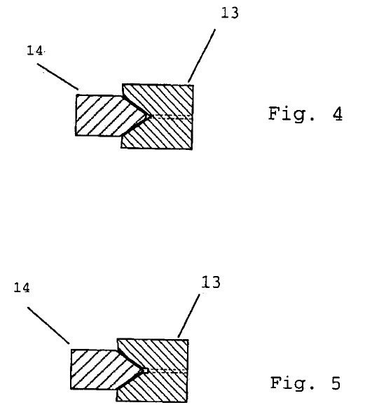

FIG. 4 shows detail IV of a section according to FIG. 2, in this version the tip of the brake shoe 14 being broken, by which a lumen forms at the contact point of the tip of the brake shoe 14 and the wedge-shaped groove 112 of the brake drum, and

FIG. 5 shows detail V of a section according to FIG. 2, in this version the abaxial base of the wedge-shaped groove 112 of the brake drum having an additional recess with a rectangular or rounded cross section, by which a lumen forms at the contact point of the tip of the brake shoe 14 and the wedge-shaped groove 1 12 of the brake drum.

In particular, FIG. 1 shows a section perpendicular to the axis through a configuration comprising the inner drum surface 11 and the brake shoes 14 which interact with it, in this preferred embodiment both the inner drum surface and also the brake shoes being made with ceramic friction layers 111, 141. The brake shoes 14 are made at least on the peripheral part 142 with a wedge-shaped cross section and fit into a wedge-shaped groove 112 in the inner drum surface (FIG. 2). Here two brake shoes 14, 14′ are shown which are caused to engage the inner drum surface and are released again by an actuating means which comprises an actuator 151 and return means 12, 152. Preferably the brake shoes 14 have a sickle-shaped cross section. The actuator 151 is made here as a cam disk which in interaction with the brake shoes 14 by turning the cam disk 151 presses the brake shoes 14 to the outside in the direction of the inner drum surface 11. The ceramic material of the friction layers 111, 141 is preferably a silicon carbide ceramic (“C—SiC”) reinforced with carbon fibers. But it is also possible within the scope of the invention to use other ceramic materials, for example based on oxide ceramics such as aluminum oxide, or carbon which has been reinforced with carbon fibers. The closed construction for the latter case also enables use of protective gases, by which the reason for hindrance of oxidative sensitivity of these systems is eliminated.

The drum brake 1 according to the invention has at least one ceramic friction layer on one of the interacting friction surfaces selected from the inner drum surface 11 which acts as a rotor and the brake shoes 14 which interact with it as the stator. Preferred embodiments will become apparent from the dependent claims.

In one preferred embodiment, in the center of the wedge-shaped groove 112 at least one channel 13 which is open to the outside is formed and points radially to the outside and preferably has a circular cross section; it is especially preferred that these channels 13 be distributed over the entire periphery of the wedge-shaped groove.

FIG. 2 shows the section II-II according to FIG. 1, to improve clarity here only the brake shoes 14, 14′ and the brake drum 13 being shown. The inner drum surface 11 has the profile of a “V” which is pointed with the tip to the outside, away from the center, into which the abaxial peripheral region 142 of the brake shoe 14 which is made with a wedge-shaped cross section fits. Various embodiments of the detailed region designated as “IV, V” are shown in FIGS. 4 and 5, a lumen designed for holding dirt and wear particles being formed according to FIG. 4 by breaking of the tip of the wedge-shaped region 142 of the brake shoe 14 together with the V-shaped base of the profile of the wedge-shaped groove 112 of the brake drum, and in another embodiment as shown in FIG. 5, by deepening the base of the V-shaped profile of the brake drum 13 with an additional rectangular or rounded recess. The recess as shown in FIG. 5 and the broken edge as shown in FIG. 4 extend of course over the entire periphery of the inner drum surface or the length of the brake shoe. For reasons of production engineering, instead of the rectangular recess such as shown in FIG. 5, a shape can be preferred in which the edges on the base of the recess are rounded, as well as a rounded profile of the brake shoe 14 as shown in FIG. 4. FIG. 3 shows one embodiment of guiding a brake shoe 14 by a combination of a pin 14011 with a circular hole 1401 on the one hand and a pin 14011 in interaction with an oblong hole 1402. But it is preferred that the two guides be made with oblong holes as is shown in FIG. 1.

There are preferably at least two brake shoes 14. For reasons of production engineering and actuation, in the case of the brake shoes shown in the drawings a maximum of 12 brake shoes is preferred. Odd numbers of brake shoes are especially favorable, for odd numbers the noise development being less than for even numbers. The brake shoes 14 are guided by at least two guides 1401, 14011, 1402, 14011 at a time, at least one of the guides being formed by a combination of a pin 14011 and an oblong hole 1402. If the two guides are made with oblong holes, it is furthermore preferred in the case of mechanical actuation by a cam disk to provide more than one, especially at least two cams for each brake shoe, and it can be ensured by a plurality of cams that the peripheral-side edge and the peripheral-side surfaces of the brake shoes are at latest always concentric to the axis for friction engagement with the inner drum surface. Instead of the guidance shown in the drawings, guidance by crosspieces is also advantageous and possible.

The problem of the varied action of the two brake shoes (primary and secondary brake shoes) which is characteristic of drum brakes in the version with two shoes can be avoided in the design according to the invention when there are two, or in embodiments with more than two brake shoes, preferably all brake shoes as primary shoes. However, in this version, when driving in reverse these shoes act as secondary shoes, with the corresponding reduced braking action; but this can be tolerated for this mode of operation.

The brake shoes are each moved back by one or more return springs 12, 152 into the rest position when the actuator 151 which actuates them returns into its initial position or the pressure using which the actuator 151 is positioned is eased. Advantageously a common spring 12, 152 can also be used, as is shown in FIG. 1, the springs being supported on support points 121.

It is of course also possible within the scope of the invention to directly and individually actuate the brake shoes by electromechanical actuators, such as piezoelectric or electromagnetic actuators, or by pneumatic or hydraulic actuators. If the brake shoes are made in the form of pins or flat cuboids as shown in claim 15, guidance by sleeves is preferred. Due to the smaller amount of space required in this case, especially in the case of brake pins, much larger numbers of these brake pins can be implemented, for example up to 100 brake pins.

The channels can be machined in the radial direction by hard machining (drilling, in conductive ceramic materials such as silicon carbide bonded with silicon (SiSiC) also by spark erosion). Another possibility is that of forming the channels in the production of the inner drum lining from two half disks by machining the half disks in the plane of separation, in this case there not being any limitation to radial channels, but it can also be made with an involute-shaped contour as shown in FIG. 1.

In operating tests with a drum brake according to the embodiment from FIG. 1, it has been shown that in other respects for drum brakes the problematic rapid fading during heating by larger braking power is absent, but better protection even in corrosive environments (moisture, salt water) and against mechanical damage offers the expected advantage. In particular for severe operating conditions therefore drum brakes according to the invention are conversely preferred to more sensitive disk brakes with ceramic brake rings.

In these operating tests it has been furthermore surprisingly found that in operation of a drum brake according to this invention, at least one of the interacting friction surfaces being made from a ceramic material, no disruptive noise development occurred, in contrast to disk brakes with ceramic friction pairs.

### REFERENCE NUMBER LIST

1 drum brake
11 inner drum surface
111 ceramic friction layer
112 wedge-shaped groove in the inner drum surface
12, 152 return springs
121 attachment point for return springs
13 channel
14, 14′ brake shoes
1401 guide hole
14011 pin
1402 oblong guide hole
141 ceramic friction layer
142 wedge-shaped region of the brake shoe 14
151 actuator, cam disk
16 guide

1. A drum brake comprising:
brake shoes,
an inner drum surface having at least one interactive friction surface: and
at least one ceramic friction layer on one of the interacting friction surfaces;
wherein the ceramic friction layer acts as a rotor the brake shoes interact with the ceramic friction layer as the stator.

2. The drum brake according to claim 1, wherein both the inner drum surface and the brake shoes comprise ceramic friction layers.

3. The drum brake according to claim 1, wherein the brake shoes are made at least on the peripheral part with a wedge-shaped cross section and fit into a wedge-shaped groove in the inner drum surface.

4. The drum brake according to claim 1, comprising at least two brake shoes which are caused to engage the inner drum surface and are released again by an actuating means which comprises an actuator and a return means (12, 152).

5. The drum brake according to claim 1, wherein the ceramic friction layer is a silicon carbide ceramic reinforced with carbon fibers.

6. The drum brake according to claim 4, wherein the actuator presses mechanically on the brake shoes to the outside in the direction of the inner drum surface.

7. The drum brake according to claim 4, wherein the actuator is actuated by an electromechanical actuator selected from the group consisting of a piezoelectric actuator and an electromagnetic actuator.

8. The drum brake according to claim 4, wherein the actuator is actuated by a mechanical actuator selected from the group consisting of a pneumatic actuator and a hydraulic actuator.

9. The drum brake according to claim 4, wherein the actuator is made as a cam disk with at least one cam per brake shoe, such that by turning the cam disk the brake shoes being pressed to the outside in the direction of the inner drum surface.

10. The drum brake according to claim 9, wherein the brake shoes have a sickle-shaped cross section.

11. The drum brake according to claim 3, wherein in the center of the wedge-shaped groove comprises at least two channels which channels are open to the outside, the channels being distributed rotationally symmetrically over the entire periphery.

12. The drum brake according to claim 1, comprising an odd number of brake shoes.

13. The drum brake according to claim 9, wherein the brake shoes are guided by at least two guides at a time in the radial direction, at least one of the guides being formed by a combination of a pin and an oblong hole.

14. The drum brake according to claim 4, wherein the brake shoes are guided by crosspieces or sleeves.

15. The drum brake according to claim 14, wherein the brake shoes are made in the form of pins rounded on the engagement surface of the inner drum surface or flat cuboids, and are guided in sleeves.

16. A drum brake comprising:
a drum, having an inner drum surface forming a friction surface; and
a brake shoe having a friction surface;
wherein at least one of the inner drum surface and the brake shoe comprise a ceramic layer as the respective friction surface.

17. The drum brake of claim 16, wherein the ceramic is a silicon carbide ceramic, reinforced with carbon fibers.

18. The drum brake of claim 16, wherein each of the inner drum surface and the brake shoe comprise a ceramic layer as the respective friction surface.

19. The drum brake of claim 16, wherein at least one of the inner drum surface and the brake shoe comprise a plurality of ceramic layers as the respective friction surface.

20. The drum brake of claim 16, wherein the inner drum surface has a depressed profile, into which the brake shoe is inserted.
